(19) United States
(12) Patent Application Publication
(10) Pub. No.: US 2012/0023051 A1
(43) Pub. Date: Jan. 26, 2012

(54) SIGNAL CODING WITH ADAPTIVE NEURAL NETWORK

(76) Inventors: Ramin PISHEHVAR, Ottawa (CA); Christopher Srinivasa, Ottawa (CA); Hossein Najaf-Zadeh, Stittsville (CA); Frederic Mustiere, Ottawa (CA); Hassan Lahdili, Gatineau (CA); Louis Thibault, Gatineau (CA)

(21) Appl. No.: 13/188,915

(22) Filed: Jul. 22, 2011

Related U.S. Application Data
(60) Provisional application No. 61/366,613, filed on Jul. 22, 2010.

(51) Int. Cl. G06N 3/02

(52) U.S. Cl. 706/21

(57) ABSTRACT

The invention relates to sparse parallel signal coding using a neural network which parameters are adaptively determined in dependence on a pre-determined signal shaping characteristic. A signal is provides to a neural network encoder implementing a locally competitive algorithm for sparsely representing the signal. A plurality of interconnected nodes receive projections of the input signal, and each node generates an output once an internal potential thereof exceeds a node-dependent threshold value. The node-dependent threshold value for each of the nodes is set based upon the pre-determined shaping characteristic. In one embodiment, the invention enables to incorporate perceptual auditory masking in the sparse parallel coding of audio signals.

### CROSS-REFERENCE TO RELATED APPLICATIONS

The present invention claims priority from U.S. Provisional Patent Application No. 61/366,613 filed Jul. 22, 2010, which is incorporated herein by reference.

### TECHNICAL FIELD

The present invention generally relates to data coding and more particularly relates to systems, devices and methods for sparse coding of data using a neural network processor.

### BACKGROUND OF THE INVENTION

Many types of signals can be well-approximated by a small subset of elements from an over complete dictionary. The process of choosing a good subset of dictionary elements from an overcomplete dictionary set, along with the corresponding coefficients, to represent a signal is known as sparse approximation, sparse representation, or sparse coding. Sparse coding is a difficult non-convex optimization problem that is at the center of much research in mathematics and signal processing. Neurophysiological data obtained from the brain cortex has shown that the human brain in effect performs sparse coding of stimuli in a parallel manner using a large number of interconnected neurons. In this context, a sparse code refers to a representation where a relatively small number of neurons are active with the majority of neurons being inactive or showing low activity in a population.

Sparse coding has been used in recent years as a strong mathematical tool for the processing of image, video, and sound, see, e.g. [1] [2]. In fact, it allows the generation of shift-invariant representations of a given input signal with a good preservation of transients and other non-stationary elements. Most of the proposed approaches to generate sparse representations use the greedy approach, such as the so-called matching pursuit (MP), or one of its derivatives. However, greedy approaches, which are mathematical abstractions of the brain function, are very difficult to implement in parallel. More recently, sparse code generators based on neural circuitry have been disclosed, see for example, article [3] and U.S. Pat. No. 7,783,459 issued to Rozell et al., which is referred to hereinafter as the '459 patent, both of which are incorporated herein by reference, and also [4], [5], and [6]. These neural based architectures have the potential to better correspond to brain sparse coding, are much easier to implement, and less computationally expensive than the MP algorithm or other greedy methods.

More specifically, the '459 patent, which is incorporated herein by reference, teaches a neural network type system that implements a Local Competitive Algorithm (LCA) approach to image and video processing using Gabor kernels as dictionary elements. The LCA aims to encode a given signal with the least number of active neurons possible. In this approach, an input signal representing an image is decomposed into a plurality of signals, each matched to a specific Gabor kernel, and is then passed to a plurality of interconnected nodes. Each node has a thresholding element at its output and is cross-coupled to other nodes to dampen there excitation levels in proportion to its own output. After a settling time, the LCA-implementing network settles to a state where only a relatively small number of nodes are active, i.e. generate non-zero outputs that provide the desired coefficients in the sparse representation of the input data.

The inventors of the present invention have recognized that the LCA-based coder of Rozell, which is designed primarily for image and video processing, has some deficiencies related to its flexibility, and when other types of signals are to be coded. For example, in the LCA-based coder of Rozell each sparse representation corresponds to one static image or one frame of a video signal, so that the LCA in the disclosed form is not directly applicable for adaptive coding of time-dependent signals such as audio signals, wherein the signal varies with time within each frame of the coder. Another deficiency of the LCA-based coder disclosed by Rozell relates to its rather inflexible optimization criterion. The sparse representation generated by the LCA minimizes the Mean Squared Error (MSE) between the reconstructed and original signals. In some cases, however, the minimization of the MSE is not the most optimal approach. For example, audio coding often benefits from perceptual optimization, when perceptual differences between coded signals and original signals are of greater importance than the MSE. Same may be true in image processing as well.

Thus, it is an object of the present invention to address at least some of the aforementioned deficiencies of the prior art by providing an adaptive coder that utilizes parallel data processing and is applicable for sparsely coding time-dependent data with flexibly defined optimization criteria.

It is noted that in the preceding paragraphs, as well as in the remainder of this specification, the description refers to various individual publications identified by a numeric designator contained within a pair of brackets. For example, such a reference may be identified by reciting, “reference [1]” or simply “[1]”. Multiple references will be identified by a pair of brackets containing more than one designator, for example, [2, 3]. A listing of references including the publications corresponding to each designator can be found at the end of the Detailed Description section.

### SUMMARY OF THE INVENTION

The present invention provides a method and apparatus for sparsely representing a signal using a network of interconnected competing nodes, wherein one or more parameters of the network are adapted based on a desired shaping of the signal or a representation error thereof.

One aspect of the present invention provides an apparatus for representing an input signal in terms of one or more dictionary elements from a plurality of dictionary elements. The apparatus comprises a plurality of interconnected nodes individually associated with the plurality of dictionary elements, wherein each node has a receptive field that is based upon one of the dictionary elements and defines node sensitivity to the input signal, and wherein each node comprises a thresholding element and an internal signal source for producing an internal node signal responsive to a node excitation signal and weighted outputs of at least some of the other nodes. The apparatus further comprises a projection unit for producing the node excitations signals representing projections of the input signal upon the receptive field of the node. The thresholding elements of the nodes are provided with node-dependent threshold values that differ from each other for at least some of the nodes in accordance with a pre-determined signal shaping characteristic.

One aspect of the present invention provides a system for representing an input signal in terms of one or more dictionary elements from a plurality of dictionary elements, comprising: a) a plurality of interconnected nodes associated with the plurality of dictionary elements, wherein each node is characterized by a receptive field that corresponds to one of the dictionary elements and comprises a thresholding element and an internal signal source for producing an internal node signal responsive to a node excitation signal and weighted outputs of at least some of the other nodes; and, b) a processor comprising a projection unit for computing the node excitation signals based on the input signal and receptive fields of the nodes, a weighting unit for applying weights to outputs of the nodes to generate the weighted outputs for providing to other nodes, and a shaping unit for applying perceptual weighting to at least one of: the receptive fields of the nodes, the weighing coefficients, and thresholds of the thresholding elements.

One aspect of the present invention provides a method for sparsely encoding a signal using an apparatus implementing a locally competitive algorithm, wherein a plurality of interconnected nodes receive projections of the input signal and wherein each of the nodes generates an output once an internal potential thereof reaches a threshold, the method comprising: a) obtaining a node-dependent threshold value for each of the nodesbased upon a pre-determined shaping characteristic, and b) setting different thresholds for different nodes for at least some of the plurality of nodes in accordance with the node-dependent threshold values obtained in step (a).

One aspect of the present invention provides a method for sparsely encoding a signal wherein a plurality of interconnected nodes receive projections of the input signal and wherein each of the nodes generates an output once an internal potential thereof reaches a threshold, the method comprising: generating the projections of the input signal using each of a plurality of dictionary elements, said plurality of dictionary elements comprising P time shifted copies of K time-dependent kernels that are spread in time over one frame of the input signal, each such kernel corresponding to a different frequency fₖ, wherein integers K and P are each greater than 1.

One aspect of the present invention provides a Perceptual Local Competitive Algorithm (PLCA) that takes into account perceptual differences between signals, which in application to audio signals accounts for, for example, absolute threshold of hearing and/or auditory masking. When perceptual difference measures are used, the PLCA disclosed herein is shown to have a faster convergence than the LCA for audio signals, and is robust with respect to quantization of the encoded signal. In a more general sense, the PLCA provides a generic framework whose applications is not limited to audio and include other types of signals, such as video and image, with correspondingly chosen perceptual, or more generally, signal shaping measures. The invention is not limited to any specific type of overcomplete dictionary and may be practiced using various types of kernel functions as suitable for particular applications and signal types. It enables to give selective emphasis to parts of the signal as specified in any desired domain, including but not limited to frequency domain, time domain, perceptual domain, and any combination thereof. The invention is not restricted to any specific implementation of the nodes representing neurons.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1a is a block diagram of a prior art LCA system including a plurality of interconnected nodes;

FIG. 1b is a diagram representing schematics of one node of the prior art LCA system;

FIG. 2 represents a dictionary matrix for LCA-based coding of time-dependent input signals, wherein columns are formed using time-shifted copies of a set of time-dependent kernels;

FIG. 3 is a spikegram of an exemplary coded signal obtained using the dictionary matrix of FIG. 2;

FIG. 4a is a schematic block diagram of a PLCA coder in accordance with an embodiment of the present invention;

FIG. 4b is a schematic diagram of a node of the PLCA coder of FIG. 4a;

FIG. 5 is a graph showing the absolute threshold of hearing as a function of frequency;

FIG. 6 is a graph illustrating the convergence of the LCA and PLCA coders;

FIG. 7 is a schematic block diagram of one embodiment of a shaping unit of the PLCA coder of FIG. 4a;

FIG. 8 is a graph illustrating power spectrum of a 2048-sample speech segment and the corresponding auditory mask;

FIG. 9 is a schematic Hock diagram of a PLCA coder implementing an auditory masking using adaptive to output thresholding;

FIG. 10 is a graph illustrating Gammatone windows for frequency channels h=6 and h=20; total number of Gammatone kernels H=25;

FIG. 11 is a graph illustrating temporal and off-channel masking effects with masker in channel h=4;

FIG. 12 illustrates the masking matrix Ω, the temporal block matrix Γ(h), and the off-channel decay matrix Ψ(a);

FIG. 13 illustrates the upward decay matrices Y(a,h) and the conversion of node outputs a to sensation levels ä(a);

FIG. 14 is a diagram illustrating schematics of an embodiment of the node with input thresholding.

### DETAILED DESCRIPTION

In the following description of the exemplary embodiments of the present invention, reference is made to the accompanying drawings which form a part hereof, and which show by way of illustration specific embodiments in which the invention may be practiced. It is understood that other embodiments may be utilized and structural changes may be made without departing from the scope of the present invention. Reference herein to any embodiment means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

In the context of this specification, the term “computing” is used generally to mean generating an output based on one or more inputs using digital hardware, analog hardware, or a combination thereof, and is not limited to operations performed by a digital computer. Similarly, the term ‘processor’ when used with reference to hardware, may encompass digital and analog hardware or a combination thereof. The term processor may also refer to a functional unit or module implemented in software or firmware using a shared hardware processor. The terms ‘output’ and ‘input’ encompass analog and digital electromagnetic signals that may represent data sequences and single values. The terms ‘data’ and ‘signal’ are used herein interchangeably. The terms ‘coupled’ and ‘connected’ are used interchangeably; these terms and their derivatives encompass direct connections and indirect connections using intervening elements, unless clearly stated otherwise.

Before providing a description of the preferred embodiments of the present invention, the prior art LCA-based neural network coder will be first briefly described, and terms and definitions introduced that will also be used further in the description of the exemplary embodiments of the present invention.

The LCA associate each node with an element φₘ of an overcomplete dictionary D, which is formed by a plurality {φₘ} of the dictionary elements. The dictionary elements φₘ, which partially overlap, are also referred to herein as kernels, in the prior art LCA define receptive fields of the associated nodes, which act as input filters for the nodes, allowing only components of the input signal that matches the respective receptive field to affect the node's state. When the LCA system is presented with an input image s(t), the collection of nodes evolve according to fixed dynamics and settle on a collective output {aₘ(t)}, corresponding to the short-term average firing rate of the nodes. The goal of the LCA is to generate a sparse code for a signal, with preferably only a few non-zero elements aₘ, so as to minimize the MSE, as defined mathematically by the following equation:

$$E = \frac{1}{2} {‖ s - \hat{s} ‖}^{2} + λ C ( a ) , \qquad ( 1 )$$

where the LCA-generated sparse representation of the input signal s is given by equation (1a),

ŝ=Σₘaₘ(t)φₘ (1a)

This sparse representation ŝ of the input signal is also referred to herein as the coded signal. Bold letters in equation (1) represent vectors. The elements aₘ of the vector ‘a’, which contains the resulting sparse representation {aₘ(t)}, are values read from the outputs of the nodes after the nodes in the network reach a steady state; they are also referred to as coding coefficients or simply coefficients. Furthermore, C(.) in equation (1) is the sparsity-inducing cost penalty, which is a function of the outputs ‘a’. The cost function C(.) can for example be represented by the L1-norm of neuron outputs; λ is a Lagrange multiplier.

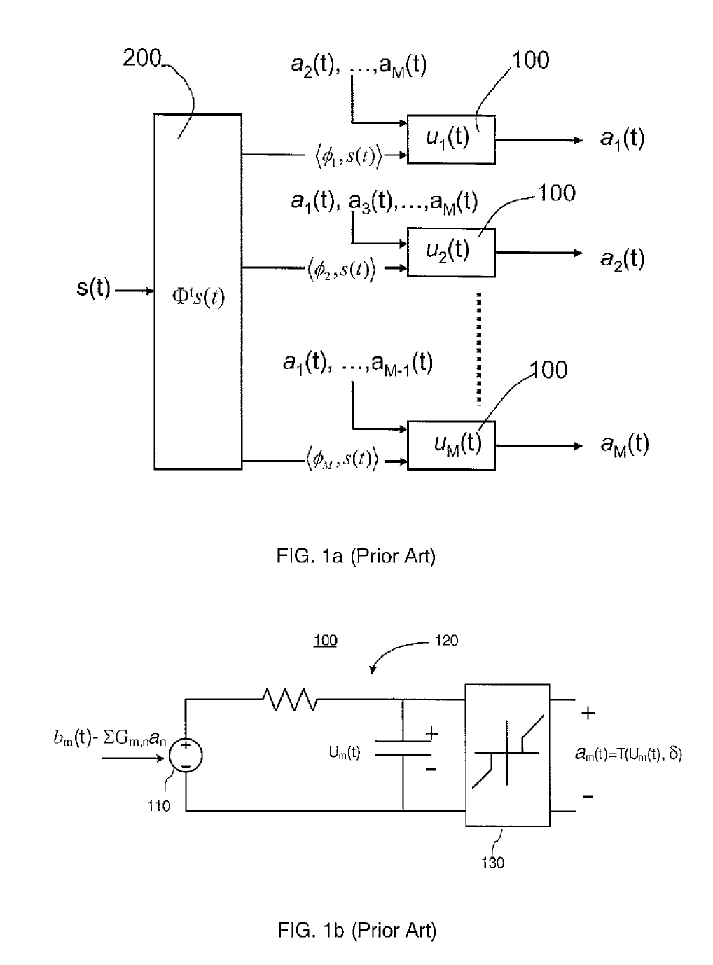

With reference to FIG. 1a, which reproduces FIG. 1(b) of the '459 patent, each element of the dictionary {φₘ} is associated with a separate ‘neuron’, which are represented by nodes 100; in the prior art LCA φₘ defines the receptive field of each neuron 100. In the context of the present specification, the terms ‘node’ and ‘neuron’ are used interchangeably. FIG. 1b illustrates internal schematics of each node, or neuron, 100 according to an embodiment of the present invention. As described in the '459 patent, the node 100 has a source of electrical energy 110, a low pass averaging circuit 120 comprised of a resistor and a capacitor, and a thresholding element 130. While the source of electrical energy 110 is shown in FIG. 1(b) as a voltage source, other arrangements such as a current source may be used in the present invention and such alternatives will be readily apparent to those of ordinary skill in the art. Likewise, while the low pass averaging circuit 120 is shown as a simple resistor and capacitor arrangement in FIG. 1(b), other arrangements may be used as will be readily apparent to those of ordinary skill in the art. The source 110 is not a “source” in the sense that it generates electrical energy, but rather, it uses received signals to produce or “compute” the output provided to the low pass averaging circuit 120 and the thresholding element 130. More specifically, the source 110 provides to the node 100 an activation signal bₙ(t) from a projection system 200 shown in FIG. 1(a), and weighted outputs from other nodes 100. In one embodiment, the source 110 in each node 100 has a weighting element corresponding to the output received from each other node for weighting that output. The source 110 outputs the difference between the node excitation signal and a sum of weighted outputs of the other nodes. The node 100 may be viewed as a leaky integrator with a thresholding element.

When the system of FIG. 1a is presented with an input s(t), the population of neurons 100 evolves according to fixed dynamics and settles on a collective output {aₘ(t)}, corresponding to the short-term average firing rate of the neurons. The goal is to define the LCA dynamics so that few coefficients aₘ(t) have non-zero values while approximately reconstructing the input. The LCA dynamics are inspired by several properties observed in neural systems: inputs cause the membrane potential to “charge up” like a leaky integrator (or spiking neuron); membrane potentials exceeding a threshold produce “action potentials” for extracellular signaling and these super-threshold responses inhibit neighboring units through lateral connections.

Dynamics of the LCA nodes, or neurons, 100 are expressed by a linear differential equation (2):

$${\dot{u}}_{m} ( t ) = \frac{1}{τ} [ {b}_{m} ( t ) - {u}_{m} ( t ) = {\sum }_{n \neq m} {G}_{m , n} {a}_{n} ( t ) ] , \qquad ( 2 )$$

This differential equation is of the same form as the well-known continuous Hopfield network. Here uₘ(t) is the internal potential of the m^{th} node, which is also referred to herein as the internal node signal, and τ is the integration time step. The node coupling coefficients The Gₘₙ, which are also referred herein as node coupling weights, and the excitation signal for the m^{th} node are given by equations (2a) and (2b);

G_{m,n}=(φₘ,φₙ), (2a)

bₘ(t)=(φₘ,s(t)). (2b)

The excitation signal bₘ(t) is defined by a projection of the input signal s(t) upon the nodes receptive field φₘ. In matrix representation, the input signal s(t) is projected onto the kernels φₘ by computing Φ^{T} s(t). Ther the matrix Φ is defined so that its rows are kernels φₘ. Projections of s(t) onto φₘ are then applies as input to nodes 100, inducing the internal node potentials uₘ(t). Contributions from other nodes have a damping effect upon the internal node potentials

The output aₘ(t) of each node/neuron 100 is defined by a nonlinearity aₘ(t)=T(uₘ(t)), where T(.) is a thresholding function. Equations (3) and (4) define relations that exist between neuron outputs, internal potentials, and sparsity factor C(a):

$$\begin{matrix}{u}_{m} = {a}_{m} + λ \frac{\partial C ( a )}{\partial {a}_{m}} & ( 3 ) \\ {a}_{m} = T ( {u}_{m} ) = \{ \begin{matrix}0 & if \vert {u}_{m} \vert < δ \\ \frac{1}{2} {u}_{m} & otherwise ,\end{matrix} & ( 4 )\end{matrix}$$

Here, δ is the threshold value and controls the sparsity, i.e. the number of active neurons. When the internal potential uₘ(t) of a given neuron 100 crosses the threshold defined in Eq. 4, the neuron becomes active, i.e. it produces a non-zero output |aₘ(t)|>0. Neurons which internal potentials are below the threshold are inactive and do not produce any output.

The thresholding function T(.) can be sigmoidal or can be a hard thresholding function, among others. Hereinafter embodiments utilizing hard thresholding function of the type defined in Eq. 4 will be described by way of example, and also because we found that the network converges better with hard thresholding when applied to audio, although other suitable thresholding functions, including those described in the '459 patent, could also be used within the scope of the present invention.

The LCA based system described in the '459 patent utilizes static Gabor kernels that do not evolve in time. One aspect of the present invention adapts the LCA to process time-dependent signals such as audio.

In one embodiment, a time-dependent input signal 11 is represented in terms of one or more dictionary elements that are selected from an over-complete dictionary D_{PK} composed of time-dependent elementary signals, or dictionary elements, wherein each of the dictionary elements is represented as a time-dependent signal or data φₘ(t). In one embodiment, the plurality of dictionary elements that forms the dictionary set D_{PK} is composed of P time-shifted copies of K base dictionary elements gₖ(t), each gₖ(t) corresponding to a different center frequency fₖ, k=1, . . . , K, where K denotes the number of frequency channels in the representation. In the case of audio signals, these base dictionary elements gₖ(t) may be, for example, gammatone filter functions or gammachirp functions. The impulse responses of the gammatone filters approach that of actual responses observed in the human hearing system, and are given, for example, in our earlier U.S. Patent Application 2008/0219466 that is assigned to the assignee of the present application, and in an article [9], both of which are incorporated herein by reference for all purposes.

The dictionary elements φₘ(t) can be realized both in analog and digital domain, for example as digital or analog filters or correlators, or in software. Considering digital implementations by way of example, the input signal s(t) is digitized and is in the form of a sequence of frames of length N each, with N being the number of signal samples in one frame. In one embodiment, the input signal s(t) is a sampled audio signal. Each dictionary element φₘ(t) may be viewed as an impulse responses of a finite impulse response (FIR) filter and mathematically represented as a vector of length N. In the dictionary D_{PK}, each base element gₖ has a length N_{gk}<N and is present in p time-shifted copies that are spread over the frame length N, preferably uniformly. In one embodiment, each consecutive copy of a base element gₖ is shifted by q samples from the previous copy, thereby sampling teach frame of the input signal s(t) with a sampling period q=N/P, which is referred to herein as the hop size.

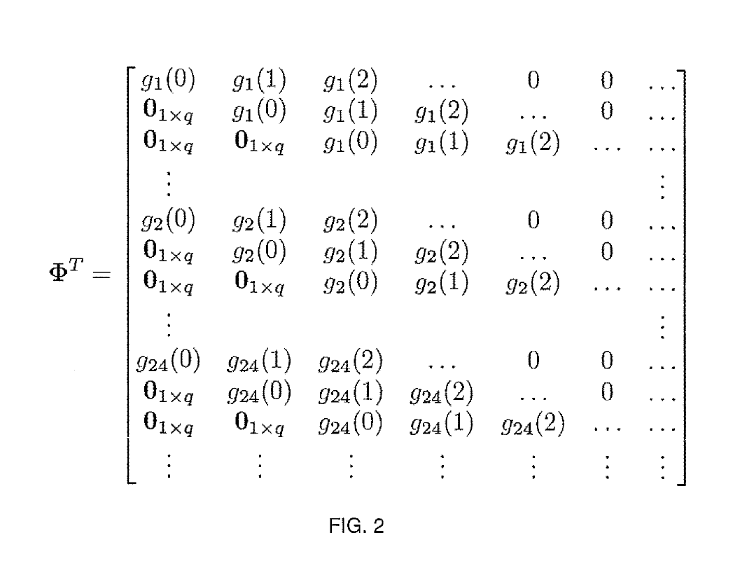

With reference to FIG. 2, the plurality of the dictionary elements {φₘ(t)}, 1, . . . , M, where M=PK, obtained thereby may be represented as a matrix Φ, which transpose Φ^{T} is shown in FIG. 2. In one embodiment, gₖ(n), n=1, . . . , Nₖ corresponds to the impulse response of the gammatone filter with center frequency fₖ. ‘0_{1×q}’ is a row vector of zero elements of length q. The matrix Φ^{T} is of dimension (K·P)×N, K being the number of channels. By way of example, K=24, and the length of the signal frame N=2048. The matrix Φ^{T} is of the form that is sometimes referred to in the signal processing literature as a stacked banded Toeplitz FIR filter matrix. Columns of the projection matrix Φ represent dictionary elements φₘ(t), in =M, of the dictionary D_{PK} of size M. They form the base in which the signal s(t) is to be represented. The matrix Φ is also referred to herein as the dictionary matrix or the coding matrix.

In one embodiment of the present invention, the LCA system of a general architecture of FIG. 1a includes a projection system 200, which embodies the dictionary D_{PK} composed of the M=K·P time-dependent dictionary elements φₘ(t), as represented by the matrix Φ of FIG. 2. The projection system 200 receives one frame of the signal s(t), and computes NI projections bₘ(t) according to equation (2b), i.e. as dot products in the vector representation of the dictionary elements and the input signal.

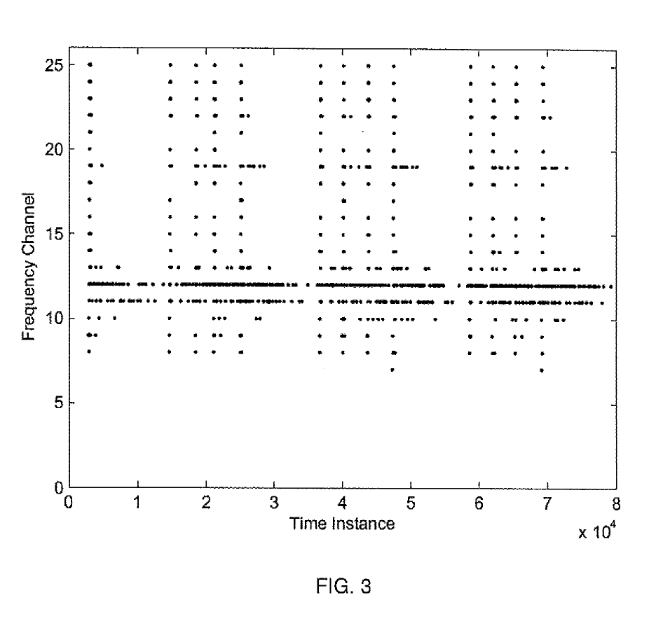

Each of these M projections bₘ(t) is passed as a node excitation signal to a respective node 100, with the total number of nodes receiving the excitation signals being M=K·P. After a network settling time, steady-state outputs aₘ of those nodes 100 that remain active form a sparse representation of the input signal frame. Such a representation is illustrated in FIG. 3 in the form of a spikegram, wherein each active node is shown as a dot in a (time, frequency) plane. In other words, each dot on the spikegram at time sample t and frequency fₖ represents a spike at the output of the neuron 100 corresponding to a dictionary element φₘ(t) formed of a k^{th} kernel positioned at time 1. For the sake of clarity, spike amplitudes are omitted in FIG. 3. By way of example, channel k corresponds to frequencies fₖ ranging from 0-20 kHz.

The projection system 200 may be implemented in an analog domain, for example using a suitable bank of time-shifted gammatone filters as described hereinabove or other suitable time-shifted kernel functions gₖ(t). The projection system 200 may also be implemented digitally for example by storing elements of the projection matrix Φ in memory, and using a digital processor implementing a suitable matrix-vector multiplication algorithm. Mixed digital-analog implementations are also possible.

Computer simulation results demonstrating convergence of the afore-described LCA technique in dependence upon the hop size q, which represents temporal quantization, is described in [10], which is incorporated herein by reference. We found that the modified LCA technique is more robust than the MP to temporal quantization. The better performance of the modified LCA can be attributed to its self-organizing capacity (through lateral inhibitions) and global optimization behavior. Furthermore, the advantage of the modified LCA over MP is in its low computational complexity and its ability to be implemented in VLSI.

Another aspect of the present invention enables to flexibly shape the accuracy with which different components of the input signal s(t) are represented in the encoded signal ŝ(t). Although this shaping can take different forms within the scope of the present invention, the general approach of the present invention to such shaping will be description hereinbelow with reference to perceptual shaping of coded audio signals. However, the approach that will be now described with reference to exemplary embodiments, can also be applied to other types of shaping, such as shaping of coded images, either perceptual or otherwise, in LCA-type image and video processing, as well as error shaping in LCA coding of other types of signals.

An aspect of the present invention provides a method for sparsely encoding a signal using an apparatus implementing a locally competitive algorithm, wherein a plurality of interconnected nodes receive projections of the input signal and wherein each of the nodes generates an output once an internal potential thereof reaches a threshold. The method comprises the steps of a) obtaining a node-dependent threshold value for each of the nodes based upon a pre-determined shaping characteristic, and b) setting different thresholds for different nodes for at least some of the plurality of nodes in accordance with the node-dependent threshold values obtained in step (a).

In one embodiment of the method, the pre-determined shaping characteristic comprises perceptual sensitivity data related to perceptual significance of various components of the signal, and wherein step (a) comprises computing the node-dependent threshold values using the perceptual sensitivity data.

In one embodiment of the method, the pre-determined shaping characteristic comprises perceptual masking data, and wherein step (a) includes computing the threshold values in dependence upon the signal so as to account for perceptual masking of signal components by adjacent signal components.

In one embodiment of the method, the receptive field of each of the nodes comprises the dictionary element associated therewith that is modified based on the shaping characteristic.

In one embodiment of the method wherein the pre-determined shaping characteristic comprises perceptual masking data, the method comprises modifying each of the dictionary elements based on the pre-determined shaping characteristic to determine the receptive fields of the nodes. In one embodiment, step (c) comprises modifying each of the dictionary elements in dependence upon the signal. In one embodiment, step (c) comprises using perceptual masking data to modify each of the dictionary elements in dependence upon the signal. One embodiment of the method comprises using the receptive fields obtain in step (c) for computing the projections of the signal for receiving by the nodes, and for computing coupling coefficients characterizing competitive coupling between the nodes.

The prior art LCA, as disclosed in the '459 patent, provides a signal approximation that is optimal in a mathematical sense, i.e. it minimizes the MSE between the original and the coded signals. However, in audio coding, as well as image and video coding, a coder that minimizes a reconstruction error as perceived by a human is preferable over a coder that minimizes the mean-square error. In the case of audio signals, the human ear perceives sounds differently at different frequencies, which is reflected in a frequency dependence of the so-called absolute threshold of hearing. Furthermore, the human ear may not perceive an artifact in the audio signal when a strong sound component is present in the vicinity thereof in the time-frequency plane, the phenomenon that is known as auditory masking. Therefore, a modified LCA that uses a perceptual metrics in generating the sparse signal representation may provide a better reconstruction quality of the audio signal at a lower bitrate.

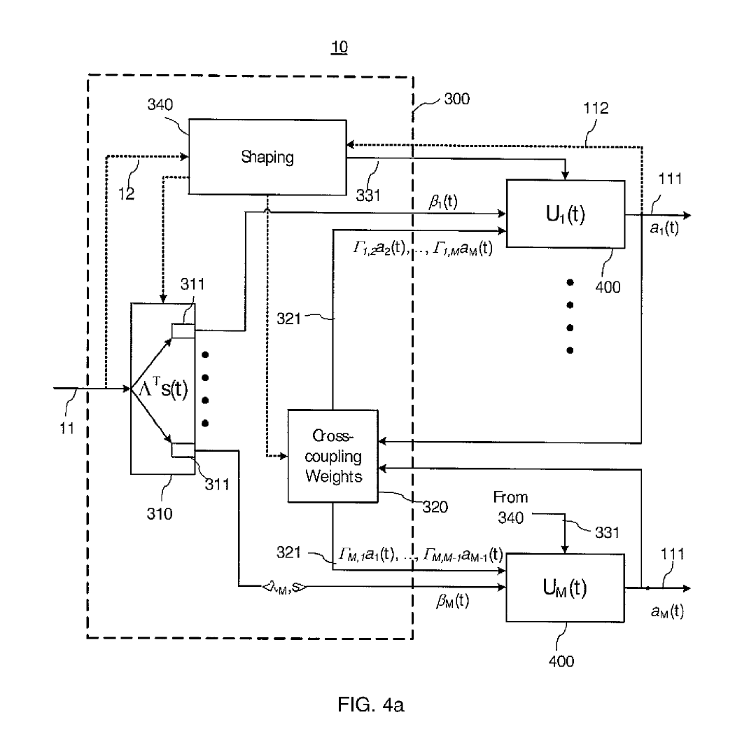

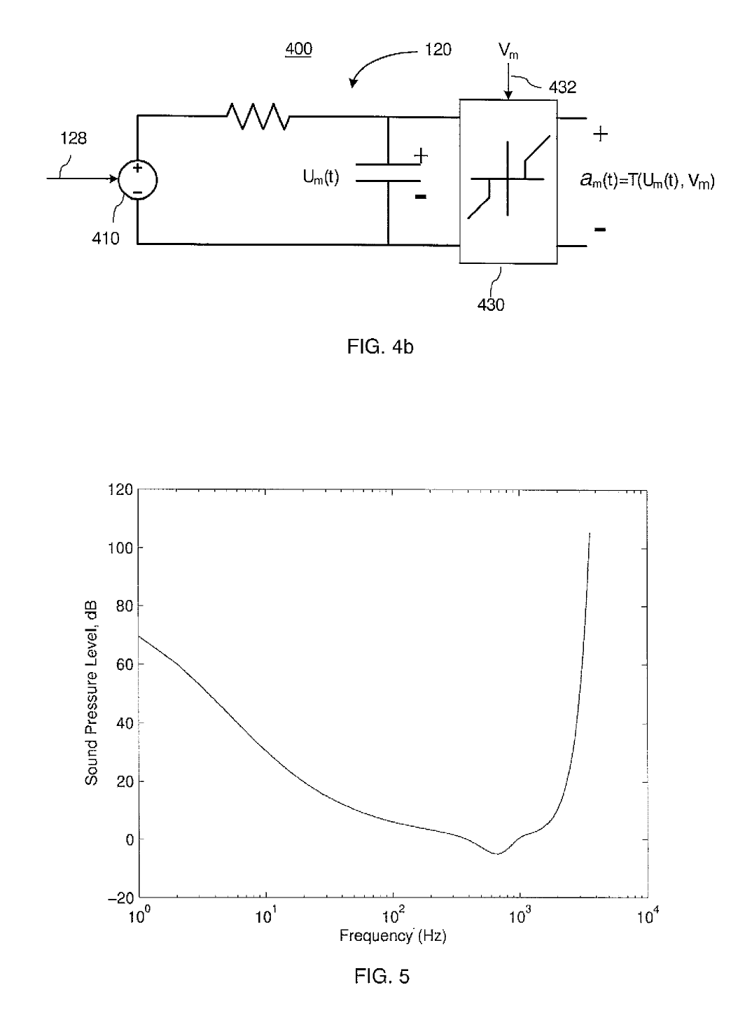

Embodiments utilizing a perceptual local competitive algorithm (PLCA) in accordance with aspects of the present invention are described hereinbelow with reference to block diagrams shown in FIGS. 4a, 4b, 7, 9 and 14. Blocks shown in this figures represent functional units that can be embodied using dedicated or shared digital hardware, analog hardware, or a combination thereof, including one or more digital processors, VLSI, FPGI, or in software that is executed by a digital processor or processors, including any combination thereof.

Furthermore, the term ‘PLCA’ is not limited to perceptual coding, but is used herein to refer to any modification of the prior art LCA that incorporates shaping of the coded signal in dependence on a pre-determined shaping characteristics or criterion.

Referring first to FIG. 4a, there is shown a schematic block diagram of an PLCA apparatus 10, also referred to herein as the PLCA coder 10 or simply as the coder 10. It includes a plurality of interconnected nodes 400, also referred to herein as neurons 400, and a connection processor (CP) 300, which in turn includes an input projection unit 310, a weighting unit 320, and a shaping unit 340. The term “unit” as used herein is not limited to a single element but encompasses hardware, software, firmware, and any combination thereof capable of performing respective functions as described herein. Embodiments of the coder 10 implement time-invariant and/or time-varying shaping filters. The time invariant PLCA may be used, for example, to implement a perceptual weighting, or shaping, of the signal coding accuracy according to the absolute threshold of hearing. The time-varying PLCA may be used, for example, to shape the coding accuracy according to pre-determined audio masking characteristics. Although the following description will refer primarily to perceptual coding of audio signals, general principals of operation of the coder 10 as described hereinbelow using mathematical representation of signals and signal processing operations is sufficiently generic and can be applied to other applications such as image and video coding.

First, we describe mathematical foundations of a PLCA-based coder that generates a sparse signal representation for a given time-invariant shaping filter, which shapes the signal coding error e=(s−̂s) in a desired way. Denoting the impulse response of the desired error-shaping filer w(n), one embodiment of the PLCA coder 10 is constructed in such a way that it minimizes the error function defined by equation (5):

$${E}_{p} = \frac{1}{2} {‖ w ( n ) * ( s ( n ) - \hat{s} ( n ) ) ‖}^{2} + λ C ( a ) , \qquad ( 5 )$$

In one embodiment, by convolving the error e between the input signal s and the reconstructed signal ŝ with the shaping filter w(n), we perceptually reshape the spectrum of the error.

Equations (6) describe the dynamics of a desired neural network minimizing the perceptually shaped error given by equation (5):

$${\dot{u}}_{m} ( t ) = \frac{1}{τ} [ {β}_{m} ( t ) - {u}_{m} ( t ) - {\sum }_{n \neq m} {Γ}_{m , n} {a}_{n} ( t ) ] \qquad ( 6 )$$

Details of the derivation of these equations can be found in [10], which is incorporated herein by reference. The new node excitation signal βₘ and node synaptic weights Γ_{m,n} are given by the following equations:

Γ_{m,n}=(λₘ,φₙ), (7a)

βₘ(t)=(λₘ,s(t)). (7b)

Here, λₘ, represents new receptive fields of the nodes 400, which are modified in accordance with the desired shaping filter w(n). The new projection matrix A, which has the new receptive fields λₘ as its columns, is defined by the following equation (8):

Λ=(W·W^{T})·Φ, (8)

where the superscript ‘T’ denotes matrix transpose, and the shaping matrix W is a Toeplitz filter matrix that is given by equation (9):

$$W = [ \begin{matrix}w ( 0 ) & w ( - 1 ) & … & w ( - N + 1 ) \\ w ( 1 ) & w ( 0 ) & … & w ( - N + 2 ) \\ ⋮ & ⋮ & ⋮ & ⋮ \\ w ( N - 1 ) & w ( N - 2 ) & … & w ( 0 )\end{matrix} ] \qquad ( 9 )$$

Columns of the shaping matrix W are time-stepped copies of the impulse response (IR) of the shaping filter w(n), so that W_{i,j}=w(i−j).

Matrix Φ is formed of the dictionary elements φₙ, for example as represented in FIG. 2, and is also referred to as the dictionary matrix. In the conventional LCA, Φ also serves as the projection matrix for generating the node excitation signals for the plurality of nodes 100.

Contrary to the conventional LCA, which utilizes substantially the same output threshold values δ in the relationship (4) between the internal node signal uₘ(t) and the node's output aₘ, the output thresholds of the nodes 400 in the PLCA 10 are node-dependent. In one embodiment, these node-dependent threshold values vₘ are weighted in proportion to the frequency response W(f) of the shaping filter w(n), so that the threshold value for the m^{th} node may be computed using the following equation (10):

vₘ=δ₀·W(fₖ) (10)

wherein fₖ is the channel frequency of the dictionary element φₘ that is associated with the m^{th} node 100, and δ₀ is a proportionality constant whose value defines the sparsity of the resulting signal representation, i.e. the number of dictionary elements used in the representation, which is given by the number of active nodes.

When it is desirable to have the same number of active neurons when using signal shaping with the PLCA as with the conventional LCA without the shaping for the same input signal s, the threshold of a given neuron m in the PLCA may be elevated or reduced based on how much the spectral characteristic of the shaping filter W(t), which is defined by the Fourier transform of the shaping filter IR w(n), amplifies the energy of the signal s at frequency fₖ that is associated with the m^{th} neuron.

A time-dependent accuracy and signal shaping can be implemented within the aforedescribed framework. In one embodiment, it includes using frame-dependent shaping filters w(n) that are allowed to vary from one frame of the input signal to another. It may also be convenient to divide each coding frame of the input signal s(t) of length N into L smaller blocks of length Nₗ, so that N=L·Nₗ, and define a shaping filter wₗ(n) separately, but not necessarily independently, for each such block. Here, subscript l=1, . . . , Nₗ denotes successive blocks within a coding frame. In this case, the shaping matrix W for one length-N coding frame of the input signal s(t) may take the quasi-diagonal form,

$$W = [ \begin{matrix}{W}_{1} & 0 & 0 & 0 \\ 0 & {W}_{2} & 0 & 0 \\ 0 & 0 & {W}_{3} & 0 \\ ⋮ & ⋮ & … & ⋱\end{matrix} ] , \qquad ( 11 )$$

wherein all the elements are zeros except for a diagonal band that is formed of block shaping matrices Wₗ of equation (12), which are of the same form as the shaping matrix of Eq. 9, but defined individually over windows of length Nₗ.

$${W}_{l} = [ \begin{matrix}{w}_{l} ( 0 ) & {w}_{l} ( - 1 ) & … & {w}_{l} ( - {N}_{l} + 1 ) \\ {w}_{l} ( 1 ) & {w}_{l} ( 0 ) & … & {w}_{l} ( - {N}_{l} + 2 ) \\ ⋮ & ⋮ & ⋮ & ⋮ \\ {w}_{l} ( {N}_{l} - 1 ) & {w}_{l} ( {N}_{l} - 2 ) & … & {w}_{l} ( 0 )\end{matrix} ] \qquad ( 12 )$$

By way of example, L=10, Nₗ=2048, and N=20480.

It can be shown that a neural network defined by equations 6-8, 11, 12 minimizes a weighted error function Ep given by equation (13).

$${E}_{p} = \frac{1}{2} {\sum }_{k} {‖ {w}_{k} ( n ) * ( {s}_{k} ( n ) - {\hat{s}}_{k} ( n ) ) ‖}^{2} + λ C ( a ) \qquad ( 13 )$$

Referring again to FIG. 4a, each of the plurality of dictionary elements φₘ(t) from a dictionary D is associated with a different neuron 400, so that there is at least as many neurons 400 as there is dictionary elements in the dictionary D. Each node 400 has its own receptive field, which is based upon the dictionary element φₘ associated with the node, but may differ therefrom as described hereinbelow. Generally, receptive field of a node or neuron 400 defines it sensitivity to the input signal 11 in dependence upon temporal, spatial, and/or frequency characteristics of the signal, or generally sensitivity to any characteristic or components of the signal that is of relevance to the user. Specific structural elements implementing the receptive field of a node 400 may be embodied in a variety of ways, as will be evident to those skilled in the art, and may or may not be physically co-located with other structural elements of the corresponding node 400. For example, the plurality of receptive fields of the nodes 400 may be embodied in digital and/or analog domains, using a filter bank, separate filters that may or may not be co-located with the nodes 400, or as a plurality of correlators.

With reference to FIG. 4(b), in one embodiment each node 400 is in the form of a leaky integrator, and has a similar schematics to the node 100 of the conventional LCA system as illustrated in FIG. 1(b). It includes an internal signal source 120 incorporating an input port 410 and an integrating RC circuit, and a thresholding element 430. The internal signal source 120 produces the internal node signal uₘ(t) in response to receiving at the input port 410 node inputs 128 that are formed by the node excitation signal βₘ(t) minus weighted outputs aₘ(t) of at least some of the other nodes 400. Additionally, node 400 includes a control port 432 for receiving a threshold value vₘ for the thresholding element 430, or a value indicative of vₘ such as a threshold scaling coefficient, for example in the form of W(fₖ). The plurality of nodes 400 can be implemented using a digital processor or in analog circuitry such as in a VLSI, or as a combination of digital and analog circuitry.

Referring back to FIG. 4a, the CP 300 services connections between neurons 400, and performs initial processing of the input signal s(t) 11. In the following we will describe digital implementations of the CP 300, although respective function could also be implemented in analog circuitry, for example using suitable adaptive filters. In the digital implementations, the input signal s(t) is a digital signal, for example a sampled audio signal that may have been originated from a microphone or synthesized by a computer, and is processed by the CP 300 in frames of length N.

This digital signal is first received by a projection unit 310, which function is similar to that of the projection system 200 of the LCA system of FIG. 1(a), and is to compute the node excitations signals βₘ based on the input signal s(t) 11 and the receptive fields 311 of the nodes 400. In one embodiment, for each coding frame of the input signal s(t), the node excitations signals βₘ are computed as a projection of the input s(t), represented as a vector, onto the receptive field 311 of the m-th node 400. Projection of a signal on a receptive field of a node is an operation which output represents how well-matched is the signal to the node's receptive field; it may be embodied using an analog or digital filter, a correlator, and the like, including in software that is executed by a hardware processor, and as dedicated digital and/or analog circuitry.

The CP 300 further includes a weighting unit 320 for applying weights, also referred to herein as the node coupling coefficients, to outputs aₘ(t) 111 of the nodes 400, so as to generate the weighted outputs for providing to other nodes 400, as indicated by arrows 321. A shaping unit 340 stores a pre-determined signal shaping characteristic, and provides threshold values vₘ, or values indicative thereof, to the thresholding elements 430 of the nodes 400 as indicated with arrows 331, and optionally provides signal shaping data based thereupon to at least one of the units 310, 320, and 330, as indicated in FIG. 4a by dotted arrows connective unit 340 to respective blocks. Note that dotted arrows in FIG. 4a indicate optional connections.

In one embodiment, the signal shaping characteristic that is stored by the shaping unit 340 relates to the absolute threshold of hearing of a human ear. The absolute threshold of hearing characterizes the amount of energy needed in a pure tone such that it can be detected by a listener in a noiseless environment [7]. The absolute threshold of hearing, Θ(f) in dB, is well approximated by the following formula:

Θ(f)=3.64·(f/100)^{-0.8}−6.5·exp[−0.6(f/1000−3.3)²]+10⁻³(f/1000)⁴. (14)

The absolute threshold of hearing could be interpreted as the maximum allowable energy level for coding distortions introduced in the frequency domain and is depicted in FIG. 5. In one embodiment, the spectrum Θ(f) of the absolute threshold of hearing may be used as the frequency response W(fₖ) of the shaping filter, W(fₖ)=Θ(fₖ), and may be provided by the shaping unit 340 to the control ports 432 of the nodes 400 for setting node-dependent threshold values thereof in dependence on the channel frequency of the dictionary element φₘ(fₖ,t) that is associated with the m^{th} node 400.

In one embodiment, the spectrum Θ(f) of the absolute threshold of hearing may be used to design the signal shaping FIR filter with the impulse response w(n) yielding the filter spectral profile W(fₖ)=Θ(fₖ), for example using the frequency sampling method as known in the art. The values w(n) can then be used to compute the projection matrix Λ based on the dictionary matrix Φ in accordance with equation (8), wherein columns of Λ define the modified receptive fields λₘ of the nodes 400. This matrix Λ may be provided to the projection unit 310 for storing therein, and used in the generation of the node excitation signals βₘ in accordance with equation 7(b) as described hereinabove.

In one embodiment, the projection matrix Λ is further used to compute the weighting coefficients Γ_{m,n}, m≠n, in accordance with equation 7(a), which can be stored in the weighting unit 320 and applied to the node outputs aₙ as they are fed back to the inputs of other nodes 400.

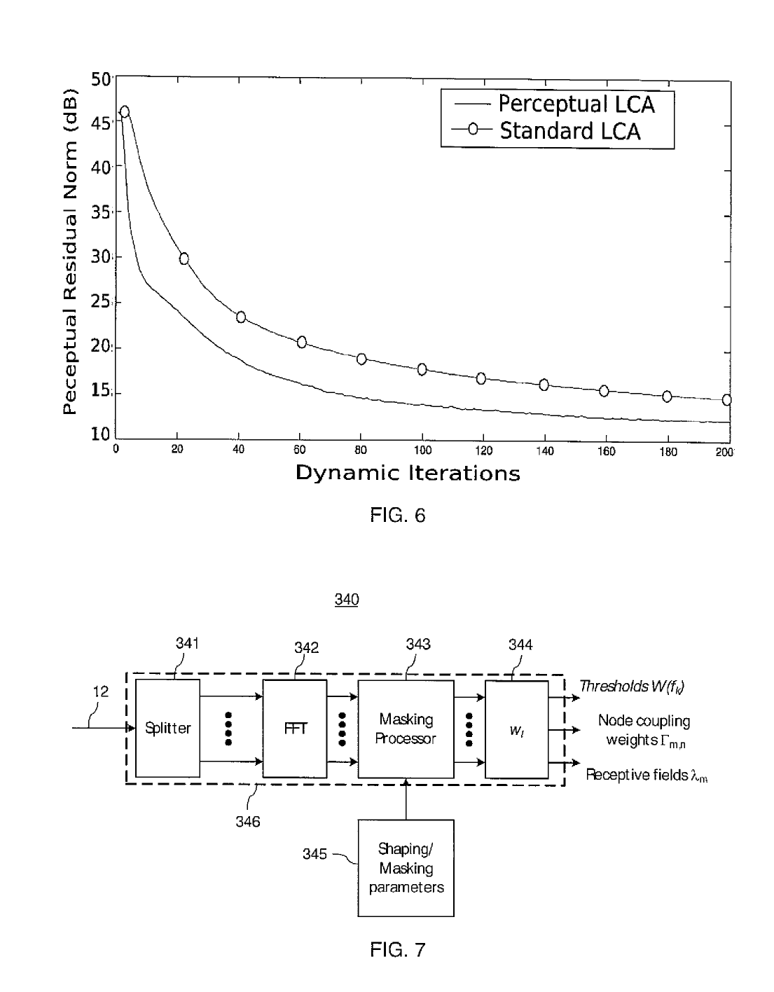

FIG. 6 illustrates how the perceptual residual norm ∥w(n)*(s(n)−̂s(n))∥ converges to a steady state with time, represented as “dynamic iterations”, for the conventional LCA and the aforedescribed embodiment of the PLCA based on the absolute threshold of hearing for a 1-second speech frame. Advantageously, the residual norm after convergence is more than 3 dB smaller for the PLCA case than for the conventional LCA, indicating that, for the same size of the coded signal, the PLCA provides better perceptual quality of the coded signal. Alternatively, this additional gain in perceptual quality can be used to reduce the bitrate of the coded signal without lack of quality as perceived by the user. Note also that PLCA convergences much faster than LCA to a given perceptual quality.

The aforedescribed embodiment of the PLCA coder 10 utilizes a constant signal or accuracy shaping characteristic, which could be stored in on-board memory of the coder 10, for example, in the form of the corresponding spectral characteristic W(fₖ) of the shaping filter, and which does not change with time and is independent on the input audio signal s(t).

In other embodiments, the coder 10 may utilize shaping characteristics that change with time and/or adapt to the input signal. One exemplary embodiment of this type relates to a PLCA implementation of auditory masking of the coded signal ŝ.

It has been shown in psychoacoustics, that strong frequency components of a sound can mask adjacent weaker frequency components by making them inaudible for the human ear. It is therefore possible in audio coding to reconstruct those masked regions coarsely without loss of perceived quality. By way of example, the embodiments of the coder 10 that we will now describe employs a variant of the MPEG Psychoacoustic model 1 [7] to determine the simultaneous masking pattern in the frequency domain.

With reference to FIG. 7, in one such embodiment, a copy of a coding frame 12 of the input signal s(t) 11 is passed to the shaping unit 340, which incorporates memory 345 for storing shaping characteristics described hereinbelow, and a signal processing unit 346 for adaptively generating the shaping filters wₗ. Each coding frame 12 of the input signal 11 is optionally split in a splitter 341 into blocks of Nₗ audio samples, wherein Nₗ is preferably a power of 2, as described hereinabove with reference to equations 11 and 12. Optionally, each signal block is windowed by a suitable, for example Hamming, window, and transformed into the frequency domain using an Nₗ-point FFT block 342. The output of the FFT block 342 is provided to a masking processor 343, for determining the tonal and noise-like components in the FFT spectrum Wₗ(f)=FFT{wₗ} of each block by finding local peaks. This enables to separate masking effects due to tonal and noise-like components. In this exemplary masking model, the masking processor 343 computes then masking thresholds due to each tonal component, and sums up all non-tonal components over critical bands associated with the frequency channels fₖ to form a single non-tonal masker in each of the critical bands. Then a masking threshold is calculated for each component above the threshold in quiet. A global masking threshold Θₜ(f) at frequency f may be determined by adding the masking threshold due to each masker to the threshold of hearing in quiet Θ_{q}(f), which is defined, for example, by the following iterative equation

$${θ}_{t} ( f ) = 10 {log}_{10} ( {10}^{( {θ}_{q} ( f ) / 10 )} + {\sum }_{j} {10}^{( \frac{θ [ z ( j ) , z ( f ) ]}{10} )} ) \qquad ( 15 )$$

Where Θ[z(j),z(f)] is the masking threshold at frequency f (or equivalently, z(f) in the Bark frequency scale [7]) due to a masker component at frequency j (or equivalently, z(j) in Bark domain). The sealed-inversed masking threshold Θᵢ(f) at frequency i is found as follows:

Θᵢ(f)=10^{6-Θ}^{ₗ}^{(f)/10}. (16)

The memory 345 stores shaping characteristics that define the used making model. By way of example, it may store, in digitized form, the Bark scale z(f) and the absolute threshold in quiet curve Θq.

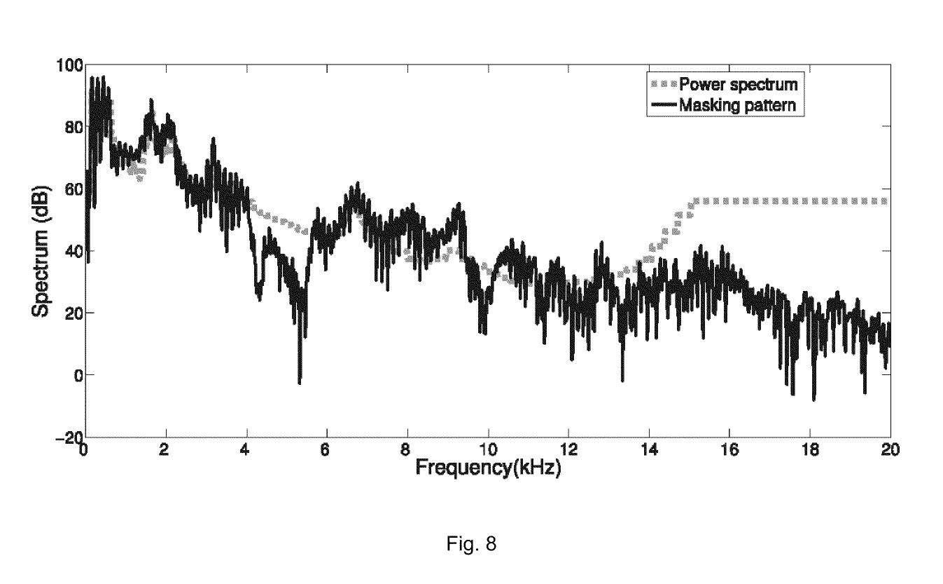

Note that this scaled-inversed masking threshold Θᵢ(f), which is also referred to herein as the spectral auditory mask, depends on the spectral profile and intensity of the input signal 11, also accounting for the absolute threshold of hearing. By way of example, FIG. 8 illustrates the auditory mask Θᵢ(f) 81 in comparison with the power spectrum 82 of a speech segment that served as the input signal 11 in generating the shown spectral auditory mask 82.

From this scaled-inversed masking threshold Θᵢ(f), which is also referred to herein as the spectral auditory mask, a shaping filter generator 344 generates shaping FIR filters using for example, the frequency sampling method. More specifically, for each audio block of length Nₗ, the shaping filter generator 344 generates the impulse response of a block shaping filter wₜ(n) that has a spectrum approximating Θᵢ(f), with l being the audio block index. These perceptual block shaping filters wₗ(n) adaptively define the shaping filter matrix W, see equations 1.1 and 12, and are used by 344 to generate the projection matrix Λ and the weighting coefficients Γ_{m,n} as described hereinabove. In one embodiment, 344 also generates the threshold values scale factor W(fₖ) for the nodes 400 using the scaled-inversed masking thresholds Θᵢ(fₖ) for each block. Note that, for each frequency channel k, an l-th audio block may be sampled by a group of nodes 400 that are associated with gammatones gₖ(t) that fall in the respective time window of the l-th audio block. Accordingly, the processor 344 provides the scaled-inversed masking thresholds Θᵢ(fₖ) for each block as the threshold scaling factors to the nodes 400 of the respective group.

Note that the splitting of the coding frames 12 of the input signal s(t) into the smaller blocks as described hereinabove is helpful in at least some embodiments of the coder 10, as it enables to have suitably long coding blocks while limiting the size of the FFT processing. This splitting is, however, optional, and the splitter 341 may be omitted in some embodiments.

In the aforedescribed embodiment, the coder 10 implements auditory masking of off-frequency channels by adaptively varying the threshold values vₘ of the nodes 400, the receptive fields λm of the neurons 400, and the weighting factors Γ_{m,n} for the node cross-coupling, in dependence upon the input signal 11. In other embodiments, adaptive shaping of the coded signal ŝ can be accomplished by varying one or two of these sets of parameters. Furthermore, the signal-adaptive shaping of the coded signal ŝ may be implemented based on the outputs 111 of the coder 10 instead of the input signal 11, as illustrated schematically by a dotted arrow 112 in FIG. 4a.

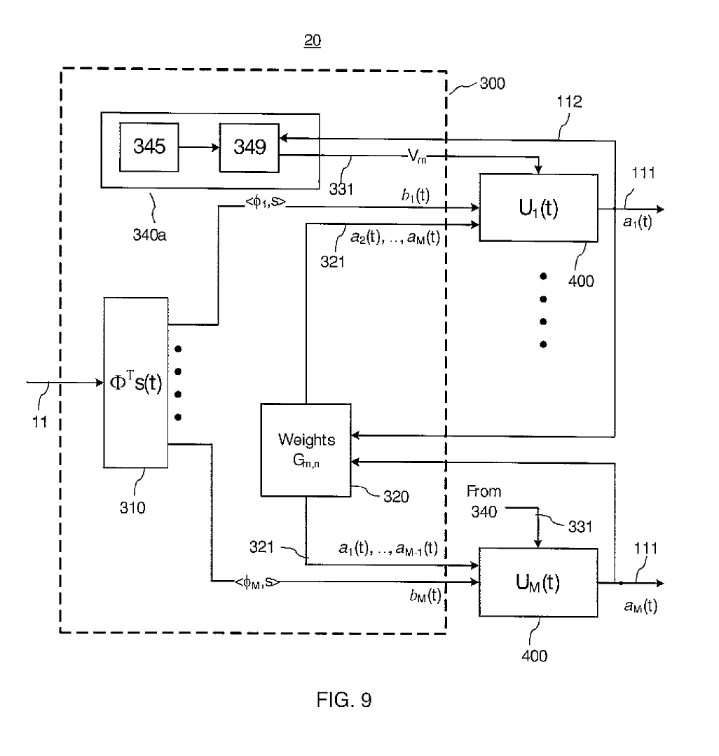

Referring now to FIG. 9, there is illustrated a PLCA coder 20 according to an embodiment of the present invention that implements perceptual frequency and temporal masking of an audio signal through input or output neuron thresholding with a feedback from the coder output. In FIGS. 9 and 4a, functionally like elements are labeled using like reference numerals and their description's will not be repeated here. The coder 20 functions generally similar to the conventional LCA system described hereinabove with reference to FIG. 1a, except that i) the dictionary matrix Φ is composed of dictionary elements φₘ of the dictionary D_{PK} that sample the input signal in time and space as described hereinabove with reference to FIG. 2, and ii) the coder 20 includes a perceptive shaping unit 340a that generates threshold values vₘ for the nodes 400 adaptively to the coder outputs aₘ 111, as described hereinbelow. The dictionary elements φₘ may use time-shifted gammatone or gammachirp kernels, or other suitable kernels.

The perceptive shaping unit 340a implements a signal-adaptive threshold update process that will now be described.

The process is based on a modification of a masking model described in an article [9], which is incorporated herein by reference. In this masking model, a masker provides both temporal masking and off-channel frequency masking. In the following description, a masker is a component of an audio signal that is strong enough so its presence ‘masks’, in perception of a listener, other audio components in its vicinity in time or frequency. The nearby components, which perception by a listener are affected by the masker, are referred to as the maskee. Furthermore, the following description is provided with reference to gammatone kernels, although other suitable types of kernels, including but not limited to gammachirp kernels, may also be used in other embodiments. A description of relevant properties of gammatone kernels is provided in [9].

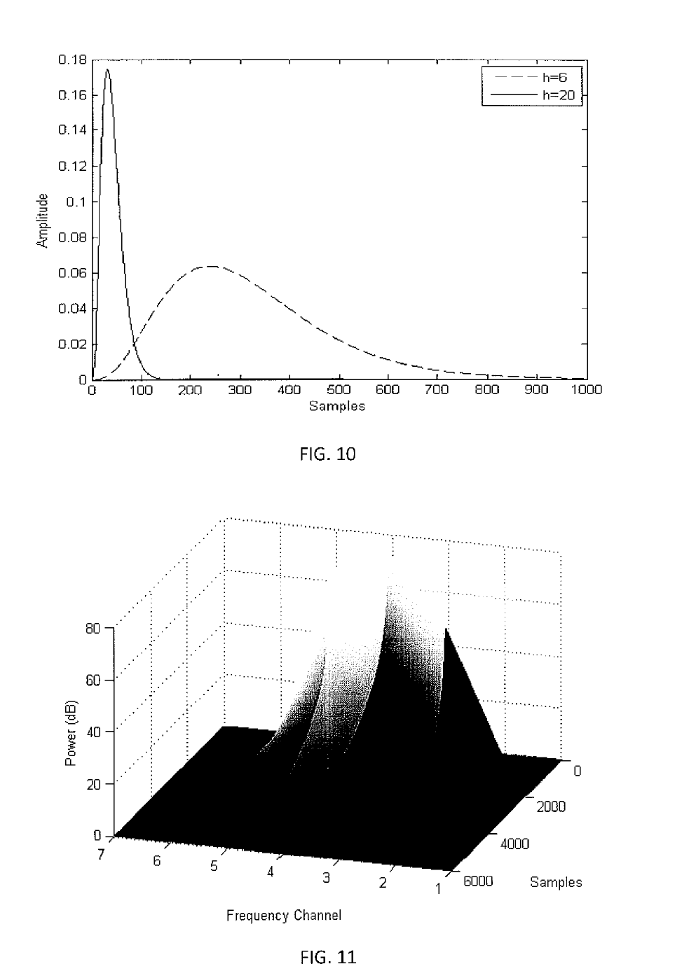

With reference to FIG. 10, there are shown two temporal masking curves zₖ(n) caused by Gammatones in two frequency channels k (denoted ‘h’ in the figure); the curves represent the strength of the effect of a masker on a maskee of the same or close frequency in dependence upon a time delay therebetween. The temporal masking curve produced by a masker contains a backward component (to mask Gammatones which occur prior to the masker), a simultaneous component (to mask Gammatones which occur at the same time as the masker), and a forward component (to mask Gammatones which occur after the masker). An exemplary mathematical description of the resulting temporal masking curve is given by eq. 17:

$${z}_{h} ( n ) = \{ \begin{matrix}\frac{{log}_{10} ( \frac{n}{- BL} )}{{log}_{10} ( \frac{1}{BL} )} , & - BL \leq n < 0 \\ 1 , & 0 \leq n \leq {L}_{h} \\ \frac{{log}_{10} ( \frac{n}{{L}_{h} + {FL}_{h}} )}{{log}_{10} ( \frac{{L}_{h} + 1}{{L}_{h} + {FL}_{h}} )} , & {L}_{h} < n \leq {L}_{h} + {FL}_{h}\end{matrix} \qquad ( 17 )$$

In this exemplary model, the backward masking length BL, i.e. the length of the trailing tail of the curves of FIG. 10, is fixed regardless of the frequency channel in which the masker occurs. By way of example, this length is set to 0.005 of the sampling frequency, by way of example 5 milliseconds in time duration. Both the simultaneous masking length L, which corresponds to the plateaus in the curves, and the forward masking length FL are functions of the frequency channel in which the masker lies, and are shorter for maskers with higher channel frequency, as the effective time duration of its associated kernel is also shorter. The simultaneous masking length is obtained as dₕFₛ, where dₕ is an effective time duration of a Gammatone kernel in a frequency channel h. The forward masking length is obtained as shown in equation (18):

FLₕ=round(100Fₛ arctan(dₕ)) (18)

The magnitude of the temporal masking curve zₕ(n), which is also referred to as the sensation level, depends on the amplitude a of the masking Gammatone, for example as defined by equation (19):

$$SL ( a , h ) = 10 {log}_{10} ( \frac{{a}^{2} {G}_{h}^{2}}{{QT}_{h}} ) \qquad ( 19 )$$

Here, Gₕ represents the maximum value of the frequency response of a normalized Gammatone kernel in channel h, QTₕ represents the threshold in quiet for channel h. The threshold in quiet is based on the absolute threshold of hearing but is elevated in certain channels due to the short time duration of Gammatone kernels in these same channels. Elevating the threshold for these channels means that the amplitude of corresponding Gammatones must be louder than that of kernels in other channels to be perceived, since they do not last as long as the other kernels. Further details on the computation of the threshold in quiet is given in [9], which is incorporated herein by reference.

The sensation level SL in equation (19) is expressed in decibels; a corresponding equation for its amplitude value can be easily obtained from eq. (19).

In a next step, the actual amount SLeff(a, h, p) by which a temporal masking curve is amplified is computed by subtracting an offset CTM(a, h, p) from the sensation level of the masker SL(a, h):

SLeff(a,h,p)=SL(a,h)−CTM(a,h,p) (20)

In one embodiment, the offset CTM(a, h, p) may be selected in dependence on the properties of the signal to be decomposed in different frequency channels and at different time positions. The offset may be set relatively higher for portions of the signal which exhibit a lot of structure, i.e. many tonal sections, and thus are more likely to be perceptually important, resulting in less masking for these portions. In contrast, signal portions which contain mostly noise may be given a smaller offset, allowing for more masking in these portions. The reader is referred to [9] for further details on the computation of the offset SL(a, h). In one embodiment, the offset CTM(a, h, p) is set to a constant value that may be chosen empirically.

Equations (17) to (20) define temporal masking effects due to a masker corresponding to a particular gammatone kernel, i.e. due to the presence of s strong output of a particular neuron 400 that is associated with the particular kernel.

### Off-Channel Masking

The exemplary model used in this implementation enables to take into account making effect on Gammatones not only in the same frequency channel as the masking Gammatone, but also in the channels just above and just below. The masking effects imparted on Gammatones which lie in a channel just below that of the masker are assumed to be equal to the temporal masking effects described in the previous section, minus an offset due to a downward channel decay parameter SLdown. In one implementation, an empirically obtained value of 27 dB is used for this decay, i.e. SLdown=27 [9]. Likewise, the masking effects imparted on Gammatones which lie in a channel just above that of the masker are equal to the temporal masking effects described in the previous section, minus an offset representing an upward channel decay SLup. In one implementation, the upward decay depends also on the sensation level of the masker and its frequency channel, for example as follows:

SLup(a,h)=24+230/fₕ−0.2SL(a,h) (21)

When combined with the original in-channel temporal masking effects, the overall masking effects of a masker can be represented by a surface in a shape of a tent in the time-frequency plane, as illustrated in FIG. 11.

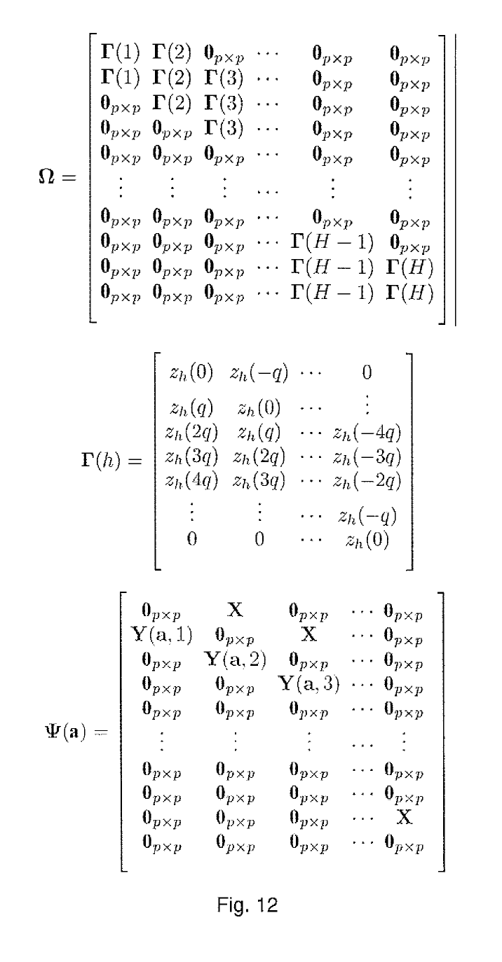

The masking model described hereinabove can be conveniently implemented within the PLCA framework using a masking matrix Ω, which is shown in FIG. 12 and which defines a masking strength decay in time and frequency. This is a square matrix of dimension pH×pH where the first p row and column indices represent the kernels of the first frequency channel for all time positions. Likewise, the next p row and column indices represent the kernels of the second frequency channel for all time positions. This continues for all frequency channels. Note that ‘H’ in FIG. 12 represents the total number of Gammatone kernels used in the PLCA, H=K, and the product pH is the total number of the dictionary elements φₘ, and the total number of nodes 400. Thus, columns and rows of the masking matrix represent node outputs and the dictionary elements associated therewith. From a masking context, the node outputs that are the maskers correspond to the columns of the masking matrix Ω, while the node outputs that are the maskees are represented by the rows. The masking effects felt by a maskee from all maskers can be obtained by taking the maximum element along the row corresponding to the maskee.

In the exemplary masking model wherein the maskers in one channel can only affect maskees in the same channel, or in channels just above and below, only the diagonal blocks of the masking matrix Ω and those just above and below the diagonal contain temporal masking matrices Γ(h). The rest of the matrix contains zeros. Note that elements of the matrices Γ(h) are not directly related to the weights Γ_{m,n} used hereinabove with reference to FIG. 4a.

Each temporal masking matrix Γ(h) represents all nodes 400 corresponding to a same frequency channel h and is of size p×p; it contains masking curves for the frequency channel which it represents. Since the columns of the masking matrix represent the maskers, the temporal curves zₕ(n) are placed in Γ(h) in a column-wise fashion facing downwards. This is analogous to each masker having its own curve in a non-matrix context. Since all kernels within a frequency channel occur at different time positions spaced by the hop size p, the masking curves zₕ(n) in successive columns of the temporal masking matrix Γ(h) are accordingly shifted downwards.

The temporal masking matrix Γ(h) shown in FIG. 12 is analogues to the weighting matrix W of equation (9) and can be seen as an embodiment thereof, with the temporal masking curves zₕ(n) embodying the shaping filters w(n).

The zero-th element of each masking curve z(0), i.e. the diagonal elements of the matrix, is set to zero to prevent a masker from imparting masking effects on itself. The first curve zₕ(n) in the matrix, i.e. first column, h=1, begins at n=0. This is because the kernel (i.e. masker) corresponding to this curve is positioned at the first time position in the spikegram and therefore cannot exhibit any backward masking effects. Likewise, the last curve in the matrix (i.e. last column) ends at n=0. This is because the kernel (i.e. masker) corresponding to this curve is positioned at the last time position in the spikegram and therefore cannot exhibit any simultaneous and forward masking effects beyond its own time position. Lastly, as the temporal masking matrix has a number of rows and columns equal to the number of time positions, the masking curves in the matrix are downsampled according to the hop size p by taking every q^{th} sample when going outwards from the masker position n=0.

The off-channel masking effects of the masking model can be taken into account by an off-channel decay matrix Ψ(a) that is illustrated in the bottom of FIG. 12. This is a square matrix of the same dimension as the masking matrix Ω. The aim of the off-channel decay matrix is to represent the downward and upward off-channel decays of a masker. As such, the frequency blocks immediately below each diagonal block in the matrix Ψ(a) contain downward decay matrices X while those above contain upward decay matrices Y(a,i), where i=1, . . . , p. Here, a is a vector composed of non-zero outputs aₘ of the neurons 400. No downward decay matrix exists for the first diagonal block and likewise no upward decay matrix exists for the last diagonal block since they represent the extreme points of the frequency channel axis. The rest of the matrix Ψ(a), including diagonal blocks, contains zeros.

Each downward and upward decay matrix is a square matrix of the same dimension as the temporal masking matrix Γ(h). Each downward decay matrix X is composed of replicas of a scalar downward decay value SLdown that may be an empirically set parameter, X SLdown_{p×p}.

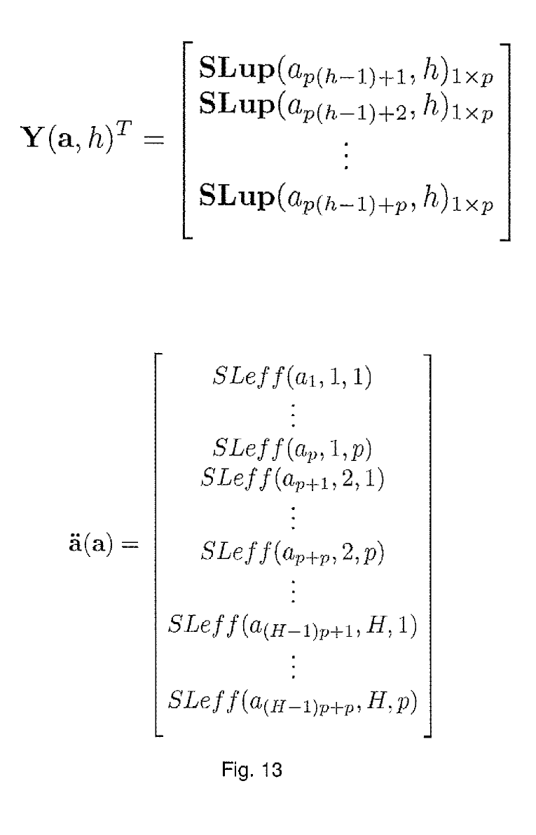

The upward decay of the masking model is a function of the amplitude and channel of the masker. As in the case of the temporal masking matrix, each column of the upward decay matrix corresponds to a masker. The upward decay matrix Y(a,h) is built by copying replicas of the upward decay of each masker for each column based on the frequency channel and amplitude of the masker, see FIG. 13, which shows the transpose of the upward decay matrix Y(a,h) for ease of viewing.

The next step in the process of adapting the masking model to the PLCA is the conversion of the neuron outputs, as the masker amplitudes, into their respective effective sensation levels SLeff(a,h,l). This conversion is shown by a second equation in FIG. 13 in a vector form, wherein vector ä contains the decibel values of the node outputs converted to effective sensation levels using equations (19), (20).

The masking effect felt by a ‘maskee’ node ‘m’ from all ‘masker’ nodes 400 can be obtained by multiplying, element by element, the m^{th} row corresponding to the maskee in the masking matrix Ω, as denoted by Ω_{(m,}_{^{−)}}, by the converted masker amplitudes ä, subtracting from the result the corresponding m^{th} row of the off-channel decay matrix Ψ(a)_{m,*}, and taking the maximum element of the resulting vector:

v′ₘ=max{[Ω_{(m,*)}ä(a)]−Ψ(a)_{(m,*)}} (22)

Here, the multiplication of a row Ω_{(m,*)} of the masking matrix by the vector ä of the converted amplitudes is an element by element multiplication representing simply a weighting of the masking matrix elements, rather than a dot product. The values v′ₘ are in decibel, and are converted to the amplitude values vₘ using equation (23):

$${V}_{m} = sign ( {v}_{m}^{′} ) \cdot SLinv ( {v}_{m}^{′} , floor ( m / p + 1 ) ) , \\ where \\ SLinv ( a , h ) = \sqrt{\frac{{10}^{a / 10} {QT}_{h}}{{G}_{h}^{2}}} \qquad ( 23 )$$

is the sensation level given by eq. (19) converted to linear domain from decibel. In Equation 2.3, the use of the sign function ensures that a masking effect which would be null (i.e. zero) in a converted domain remains zero in the amplitude domain. Note that the masking effect Vₘ felt by a maskee cannot be negative since the elements of the masking matrix and the off-channel decay matrix outside the masking zones are respectively zero, thereby meaning that some of the elements resulting from the subtraction in eq. (22) are guaranteed to be zero.

In one embodiment of the coder 20, node masking values Vₘ are used as input sensitivity thresholds of the nodes 400. In mathematical terms, the dynamics of the nodes 400 in this embodiment of the coder 20 can be described by the following equations:

$$\dot{u} = \frac{1}{τ} [ - {u}_{m} + {γ}_{m} {α}_{m} ] \qquad ( 24 )$$

where αₘ is the algebraic sum of all inputs into the m^{th} neuron:

$${α}_{m} = {b}_{m} - {\sum }_{m \neq n} {G}_{m , n} {a}_{n} \qquad ( 25 )$$

and γₘ is a binary weight, or a binary thresholding function, which sets inputs into the m^{th} neuron 400 to zero, i.e. blocks it when these inputs in total are smaller than the computed node masking values vₘ, due to the combined auditory masking effect from other active nodes:

$${γ}_{m} = \{ \begin{matrix}1 , \vert {α}_{m} \vert > \vert {υ}_{m} \vert \\ 0 , \vert {α}_{m} \vert \leq \vert {υ}_{m} \vert\end{matrix} \qquad ( 26 )$$

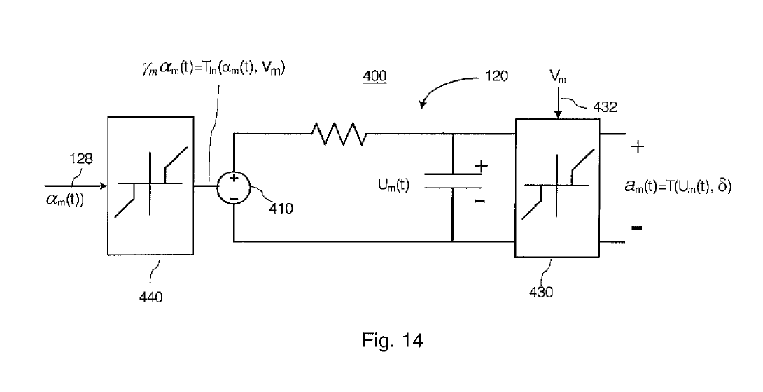

In one embodiment, this input thresholding is accomplished by providing each neuron 400 with an input thresholding element 440, as illustrated in FIG. 14, which blocks the inputs into the neuron 400 when they fell below a masking level vₘ set for the m-th neuron 400 by other neurons 400. In one embodiment, this input thresholding is accomplished by applying the binary weighting coefficients to the node excitation signals at the projection unit 310, and to respective node outputs at the weighting unit 320.

In one embodiment of the coder 20, the shaping unit 340a incorporates memory 345 that stores pre-determined signal shaping characteristics, and a masking processor 349 for implementing the adaptive perceptual shaping of the coded signal ŝ. The pre-determined signal shaping characteristics stored in memory 345 may include for example elements of the masking matrix Ω and the off-channel decay matrix Ψ, which together represent frequency and temporal auditory masking curves. The masking processor 349 receives outputs aₘ, from each of the nodes 400, as represented by the arrow 112, and, based on these outputs 112 and the signal shaping characteristics stored in 345, generates sensitivity thresholds Vₘ for the neurons 400, for example in accordance with equations (23) and (22), as described hereinabove. These sensitivity thresholds Vₘ are then provided as thresholding values to corresponding neurons 400.

Referring to FIG. 14, in one embodiment wherein neurons 400 include the input thresholding elements 440, the sensitivity thresholds Vₘ are sent to this input thresholding elements 440 to set their respective thresholds.

In one embodiment, the input thresholding element 440 coexists with the output thresholding element 430, which may have its threshold set to a node-independent value δ, as in the prior art LCA.

In one embodiment, the output thresholding element 430 may be omitted, and all thresholding functions are performed by the input thresholding element 440. In another embodiment wherein the node 400 includes only the output thresholding element 430 and the input thresholding element 440 is absent, the sensitivity thresholds Vₘ are provided to the thresholding elements 430 for setting the thresholds thereof. In these embodiment, the thresholding elements 440 or 430 of each of the neurons 400 may in addition verify whether the neuron sensitivity value Vₘ falls below a minimum threshold value δ, and if it does, set its threshold to δ, so as to ensure a desired sparsity of the resulting representation when the masking effects are weak. In other embodiments, the responsibility to ensure that the node input or output thresholds do not fall below a desired lower limit in the case of a single thresholding element may lie with the masking processor 349.

The performance of the PLCA coder 20 implementing the aforedescribed adaptive perceptual masking of the coded signal ŝ though input thresholding of the neurons has been tested using computer simulations for three input audio files, namely a castanet file, a speech file, and a percussion file. The audio quality of reconstructed signals was evaluated using the PEAQ model, which is an International Telecommunication Union (ITU) standard for evaluating audio quality. Contrary to the SNR and SSNR measures, the PEAQ model not only takes into account waveform samples when evaluating audio quality but also human behaviour in mimicking the human auditory processing system. Given a reconstructed signal and its original version, the model first pre-processes the signals based on the psychoacoustic properties of the human ear. The model then sends the resulting signals through a neural network which has been trained a priori from auditory tests with humans to mimic the cognitive aspects of the human auditory processing system. Lastly, the model outputs a set of variables which map to a score ranging between 0 and −5. Scores above −1 are said to be of broadcast quality. Based on the above evaluation metric, the performance of the PLCA with input masking, labeled LCAM in the following, against that of the LCA was thus evaluated by making use of the procedure which follows for each sound file. The threshold of the hard-thresholding function is first set for the sound file in question such that the reconstructed signal corresponding to the sparse representation produced by the LCA yields a PEAQ score above −1 (i.e. broadcast quality). The LCAM is then executed for the sound file using the threshold which was established for the file in question when using the LCA. For all three files, the LCAM yielded higher PEAQ scores than the LCA, while also exhibiting lower SNRs.

Although the invention has been described hereinabove with reference to specific exemplary embodiments, it is not limited thereto, but is defined by the spirit and scope of the appended claims. Various improvements and modifications of the aforedescribed embodiments will be apparent to those skilled in the art from the present specification. For example, although the invention has been described hereinabove with reference to coding of audio signals, the invention may be equally applied to sparse adaptive coding of other signal types, including video and images. Furthermore, various features described hereinabove with reference to particular embodiments could be used in other described embodiments and their modifications, and various embodiments may be combined. For example, the encoder 20 of FIG. 9 may be adopted to modify not only the threshold values, but also the weighting coefficients G_{m,n} and/or the receptive fields of the nodes 400 based on the pre-determined shaping function, for example to account for the perceptual masking effects as described hereinabove with reference to the encoder 10 of FIG. 4a. Although particular embodiments of the invention were described hereinabove with reference to dictionary elements based on gammatone kernels, other embodiments of the invention may utilize other types of kernels, including but not limited to gammachirp kernels, gabor kernels, wavelets, etc. Those skilled in the art will be able to select a suitable set of kernels for specific applications and signal types. Furthermore, the present invention encompasses embodiments wherein the thresholds of the nodes are selectively varied in dependence on any kind of pre-determined signal shaping characteristics, such as a priori knowledge about relative relevance of a zone in the signal representation and is not limited to those related to perceptual auditory weighting and/or masking. For example, in image coding the node-dependent weighting of one of the node thresholds, the receptive fields, and the weighting coefficients related to node coupling, can be used to select or emphasize specific regions in the image, such as those in the background or foreground.

Other embodiments and modifications of the embodiments described herein are also possible.

### REFERENCES

[1] R. Pichevar, H. Najaf-Zadeh, and L. Thibault, “A biologically-inspired low-bit-rate universal audio coder,” in Audio Eng. Society Conv., Austria, 2007.
[2] R. Pichevar and H. Najaf-Zadeb, “Pattern extraction in sparse representations with application to audio coding,” in European Signal Processing Conf., Glasgow, UK, 2009.
[3] C. Rozell, D. Johnson, D. Baraniuk, and B. Olshauscn, “Sparse coding via thresholding and local competition in neural circuits,” Neural Computation, vol. 20, no. 10, pp. 2526-2563, 2008. See also Rozell et al, U.S. Pat. No. 7,783,459; incorporated herein by reference.
[4] L. Perrinet, M. Samuelides, and S. Thorpe, “Coding static natural images using spiking event times: do neurons cooperate?” IEEE Transactions on Neural Networks, vol. 15(5), pp. 1164-1175, 2004.
[5] M. Rehn and T. Sommer, “A network that uses few active neurons to code visual input predicts the diverse shapes of cortical receptive fields,” Journal of Computational Neuroscience, vol. 22(2), pp. 135-146, 2007.
[6] K. Herrity, A. Gilbert, and J. Tropp, “Sparse approximation via iterative thresholding.” in IEEE International Conference on Acoustics, Speech, and Signal Processing, Toulouse, France, 2006.
[7] T. Painter and A. Spanias, “Perceptual coding of digital audio,” Proceedings of the IEEE, vol. 88, no. 4, pp. 451-513, 2000.
[8] R. Pichevar, H. Najaf-Zadeh, L. Thibault, and H. Landili, “Entropyconstrained spike modulus quantization in a bio-inspired universal audio coder,” in European Signal Proc. Conf., Lausanne, Switzerland, 2008.
[9] H. Najaf-Zadch, R. Pichevar, H. Landili, and L. Thibault, “Perceptual matching pursuit for audio coding,” in Audio Engineering Society Convention 124, 5 2008; incorporated herein by reference.
[10] R. Pichevar, H. Najaf-Zadeh, and F. Mustiere, Neural-Based Approach to Perceptual Sparse Coding of Audio Signals, IEEE Joint Conference on Neural Networks, 2010, Barcelona, Spain; incorporated herein by reference.

We claim:

1. An apparatus for representing an input signal in terms of one or more dictionary elements from a plurality of dictionary elements, comprising:
a plurality of interconnected nodes individually associated with the plurality of dictionary elements, wherein each node has a receptive field that is based upon one of the dictionary elements and defines node sensitivity to the input signal, and comprises:
a thresholding element, and
an internal signal source for producing an internal node signal responsive to a node excitation signal and weighted outputs of at least some of the other nodes; and,
a processor comprising a projection unit for producing the node excitations signals representing projections of the input signal upon the receptive field of the node;
wherein the thresholding elements of the nodes are provided with node-dependent threshold values that differ from each other for at least some of the nodes in accordance with a pre-determined signal shaping characteristic.

2. An apparatus of claim 1, further comprising memory for storing one of: the node-dependent threshold values, and the pre-determined signal shaping characteristic.

3. An apparatus of claim 1, wherein the processor comprises a shaping unit for computing the node-dependent threshold values based on the pre-determined signal sensitivity characteristic and in dependence upon one of: the input signal, and one or more of the node outputs.

4. An apparatus of claim 3, wherein the shaping unit is connected to receive a copy of the input signal for computing the node-dependent threshold values in dependence upon at least one of: a time dependence of the input signal, and a frequency content of the input signal.

5. An apparatus of claim 1, wherein each of the receptive fields of at least some of the nodes comprises one of the dictionary elements that is modified using the pre-determined signal shaping characteristic.

6. An apparatus of claim 1, wherein the weighted outputs of the at least some of the other nodes comprise weighting coefficients that depend upon the pre-determined signal shaping characteristic.

7. An apparatus of claim 3, wherein the shaping unit is connected to the projection unit for modifying the receptive fields based on the pre-determined signal shaping characteristic.

8. An apparatus of claim 3, wherein the processor further comprises a weighting unit for applying node-dependent weights to outputs of the at least some of the other nodes to produce the weighted outputs, and wherein the shaping unit is coupled to the weighting unit for modifying said node-dependent weights based on the pre-determined signal shaping characteristic.

9. An apparatus of claim 8, wherein the shaping unit is connected to receive one of: the input signal, and the outputs of the nodes, for adaptively modifying the receptive fields of the nodes and the weighted outputs in dependence upon one of: variations in the input signal, or variations of one or more of the node outputs.

10. An apparatus of claim 3, wherein the pre-determined signal shaping characteristics comprises perceptual masking data characterising user sensitivity to components of the signal, and wherein the shaping unit comprises a masking processor for computing at least one of: the threshold values, the weighting coefficients, and the receptive fields, in dependence upon the signal so as to account for perceptual masking of signal components by adjacent signal components.

11. An apparatus of claim 3, wherein the pre-determined signal shaping characteristics comprises perceptual masking data characterising user sensitivity to components of the signal, and wherein the shaping unit comprises a masking processor for computing at least one of: the threshold values, the weighting coefficients, and the receptive fields, in dependence upon the outputs of the nodes for perceptual masking of signal components by adjacent signal components.

12. An apparatus of claim 1, wherein the plurality of dictionary elements comprises P time shifted copies of K base dictionary elements that are spread in time over one frame of the input signal, each such base dictionary element corresponding to a different frequency fₖ, wherein integers K and P are each greater than 1.

13. A system for representing an input signal in terms of one or more dictionary elements from a plurality of dictionary elements, comprising:
a plurality of interconnected nodes associated with the plurality of dictionary elements, wherein each node is characterized by a receptive field that corresponds to one of the dictionary elements and comprises:
a thresholding element, and
an internal signal source for producing an internal node signal responsive to a node excitation signal and weighted outputs of at least some of the other nodes; and,
a processor comprising
a projection unit for computing the node excitation signals based on the input signal and receptive fields of the nodes,
a weighting unit for applying weights to outputs of the nodes to generate the weighted outputs for providing to other nodes, and
a shaping unit for applying perceptual weighting to at least one of: the receptive fields of the nodes, the weighing coefficients, and thresholds of the thresholding elements.

14. A method for sparsely encoding a signal using an apparatus implementing a locally competitive algorithm, wherein a plurality of interconnected nodes receive projections of the input signal and wherein each of the nodes generates an output once an internal potential thereof reaches a threshold, the method comprising:
a) obtaining a node-dependent threshold value for each of the nodes based upon a pre-determined shaping characteristic, and
b) setting different thresholds for different nodes for at least some of the plurality of nodes in accordance with the node-dependent threshold values obtained in step a).

15. A method of claim 14, wherein the pre-determined shaping characteristic comprises perceptual sensitivity data related to perceptual significance of various components of the signal, and wherein step (a) comprises computing the node-dependent threshold values using the perceptual sensitivity data.

16. A method of claim 15, wherein the pre-determined shaping characteristic comprises perceptual masking data, and wherein step (a) includes computing the threshold values in dependence upon the signal so as to account for perceptual masking of signal components by adjacent signal components.

17. A method of claim 14, wherein each of the nodes is associated with one of a plurality of dictionary elements, wherein the node outputs represent contributions of the dictionary elements associated therewith into a sparse representation of the signal, and
wherein the receptive field of each of the nodes comprises the dictionary element associated therewith that is modified based on the shaping characteristic.

18. A method of claim 17, wherein the pre-determined shaping characteristic comprises perceptual masking data, further comprising
c) modifying each of the dictionary elements based on the pre-determined shaping characteristic to determine the receptive fields of the nodes.

19. A method of claim 18, wherein the pre-determined shaping characteristic comprises perceptual masking data, and wherein step (c) comprises modifying each of the dictionary elements in dependence upon the signal.

20. A method of claim 19, wherein the pre-determined shaping characteristic comprises perceptual masking data, and wherein step (c) comprises using perceptual masking data to modify each of the dictionary elements in dependence upon the signal.

21. A method of claim 18, comprising using the receptive fields obtain in step (c) for computing the projections of the signal for receiving by the nodes, and for computing coupling coefficients characterizing competitive coupling between the nodes.
